(19) United States
(12) Patent Application Publication
(10) Pub. No.: US 2013/0068915 A1
(43) Pub. Date: Mar. 21, 2013

(54) DETACHABLE MOUNTING SYSTEMS FOR ELECTRONIC DEVICES

(71) Applicant: Sampson Yang, Irvine, CA (US)

(72) Inventor: Sampson Yang, Irvine, CA (US)

(73) Assignee: The Joy Factory, Inc., Irvine, CA (US)

(21) Appl. No.: 13/624,833

(22) Filed: Sep. 21, 2012

Related U.S. Application Data
(60) Provisional application No. 61/537,489, filed on Sep. 21, 2011.

(51) Int. Cl. F16M 11/00; F16M 13/02; F16M 13/00

(52) U.S. Cl. 248/551; 248/176.3; 248/126

(57) ABSTRACT

A detachable mounting system for securing an electronic device is provided. The system includes a first mounting body coupled with the electronic device, and the first mounting body includes a magnetic mounting piece. The system also includes a second mounting body capable of being coupled with a supporting base or surface, and the second mounting body includes a first end coupled to the first mounting body and a second end coupled with the supporting base or surface, with at least one of the first and second end enabling at least one of relative horizontal, vertical, pivoting, swiveling, and rotating movements of the electronic device relative to the supporting base or surface. The system also includes a magnetic securing device detachably coupled between the first mounting body and the second first end of the second mounting body through the magnetic force between the magnetic mounting piece and the magnetic securing device.

### CROSS REFERENCE TO RELATED APPLICATION

This application claims the benefit of priority to U.S. provisional Application No. 61/537,489 filed with the United States Patent and Trademark Office on Sep. 21, 2011, and entitled “DETACHABLE MOUNTING SYSTEMS FOR USER-OPERATIVE DEVICES”, which is hereby incorporated by reference in its entirety.

### TECHNICAL FIELD

The subject matter of the present application relates to detachable mounting systems for electronic devices such as touch screen devices, various generations of iPad®, tablets, tablet PCs, smart phones, and other devices that a user may mount for easier operations.

### BACKGROUND

Portable electronic devices, such as Apple's iPhone®, various generations of Apple's iPad® (including iPad 2®, etc.), Samsung's Galaxy® or Galaxy series tablets, tablets, Android® tablets, tablet PCs, smart phones, other touch-panel devices, digital cameras, camcorders, e-readers, various generations of Kindle®, various generations of Nook®, and many other devices, are becoming more and more popular and have wide varieties of applications. Some of the applications may require a device to be easily mounted to an external object, but at the same time in a secure or substantially secure manner. Some of the applications may also require that the mounted devices still have certain degree or flexibility of movement. Thus, it may be desirable to have a flexible and/or secure detachable mounting system for electronic devices.

### SUMMARY OF THE INVENTION

The present disclosure provides a detachable mounting system for securing an electronic device. According to one embodiment, the system comprises a first mounting body coupled with the electronic device, the first mounting body comprising a magnetic mounting piece; a second mounting body capable of being coupled with a supporting base or surface, the second mounting body comprising: a first end for being coupled to the first mounting body, a second end for being coupled with the supporting base or surface, wherein at least one of the first and second end enables at least one of relative horizontal, vertical, pivoting, swiveling, and rotating movements of the electronic device relative to the supporting base or surface; and a magnetic securing device detachably coupled between the first mounting body and the first end of the second mounting body for magnetically securing the first mounting body to the second mounting body through magnetic force between the magnetic mounting piece and the magnetic securing device, the magnetic securing device comprising a securing and releasing latch.

The present disclosure further provides a magnetic mounting system for securing an electronic tablet. According to one embodiment, the system a mounting piece coupled with the electronic tablet; a magnetic securing device detachably coupled with the mounting piece through magnetic force between the magnetic securing device and the mounting piece, the magnetic securing device further comprising a securing latch; at least one movable arm coupled with the magnetic securing device and a base, the at least one movable arm being coupled with the magnetic securing device and the base to enable at least one of relative horizontal, vertical, pivoting, swiveling, and rotating movements of the electronic device relative to the base.

### DESCRIPTION OF THE DRAWINGS

FIG. 1 illustrates an exemplary detachable mounting system according to an embodiment of the present disclosure.

FIG. 2A illustrates a perspective view of the second mounting body of the detachable mounting system as shown in FIG. 1.

FIG. 2B illustrates a back view of the second mounting body as illustrated in FIG. 2A.

FIG. 2C illustrates a side view of the second mounting body as illustrated in FIG. 2A.

FIG. 2D illustrates a front view of the second mounting body as illustrated in FIG. 2A.

FIG. 3 illustrates a perspective view of the first mounting body or a mounting piece of the detachable mounting system as illustrated in FIG. 1.

FIG. 4 illustrates a perspective view of the first mounting body being attached to the second mounting body of the detachable mounting system 100 as shown in FIG. 1.

FIG. 5 illustrates an exemplary embodiment of the detachable mounting system 100 as shown in FIG. 1.

### DETAILED DESCRIPTION

The aforementioned and other aspects, solutions, and advantages of the presently claimed subject matter will become apparent from the following descriptions and corresponding drawings. The embodiments further clarify the presently claimed subject matter and shall not be construed to limit the scope of the present claimed subject matter.

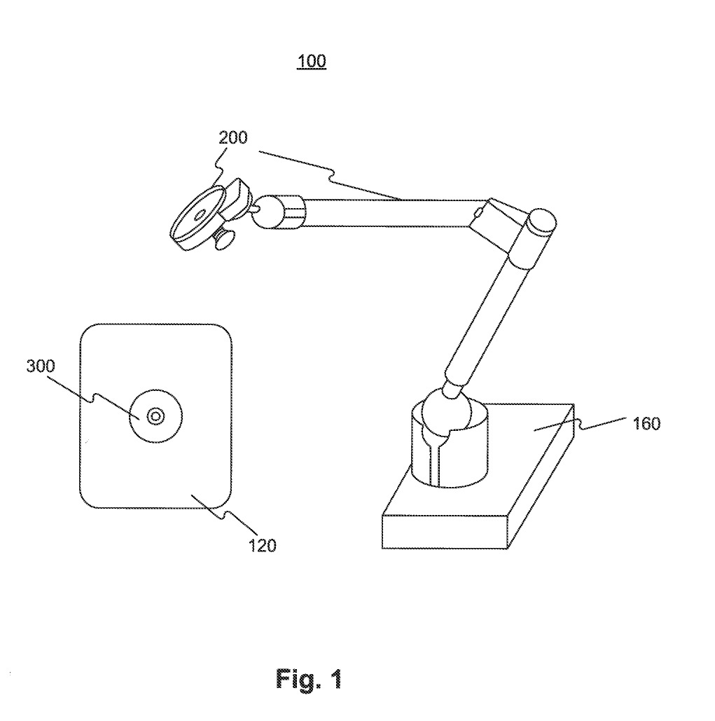

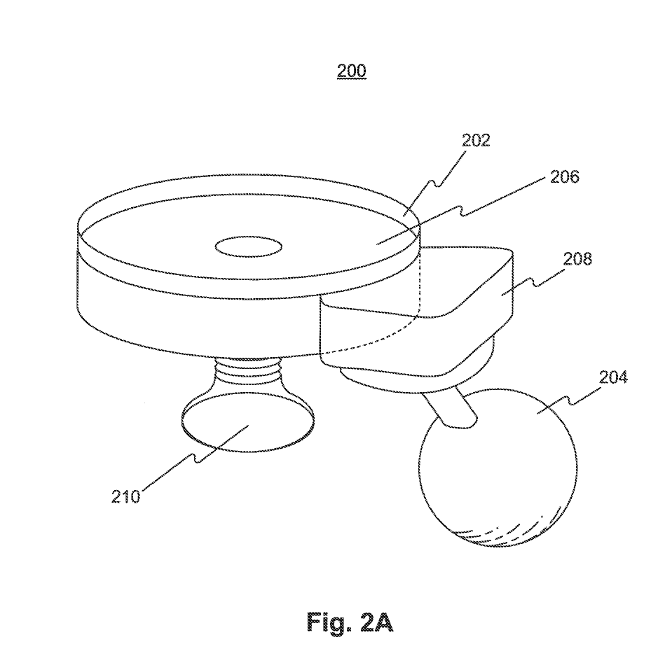

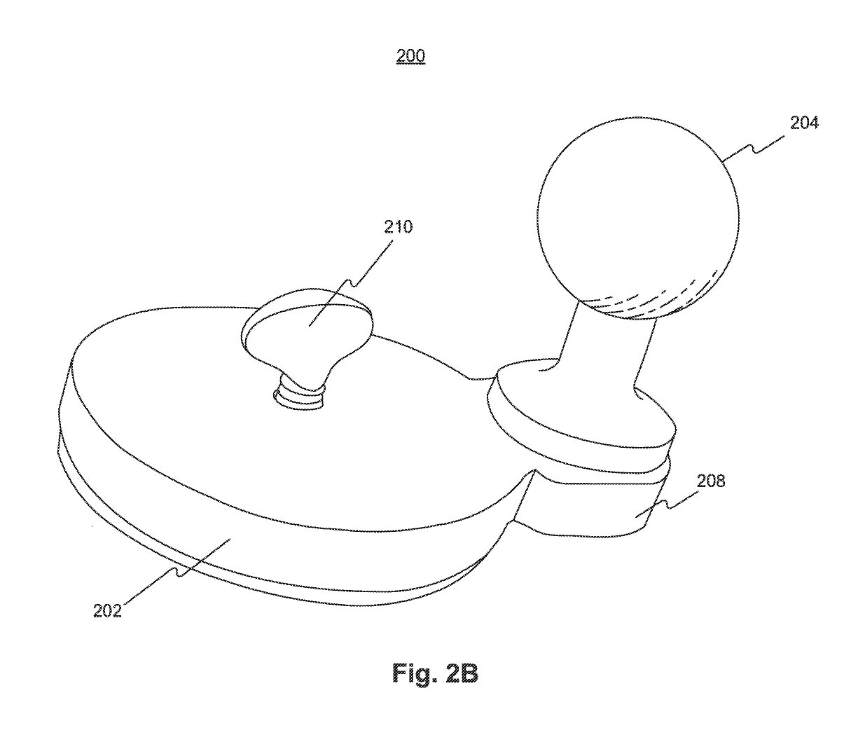

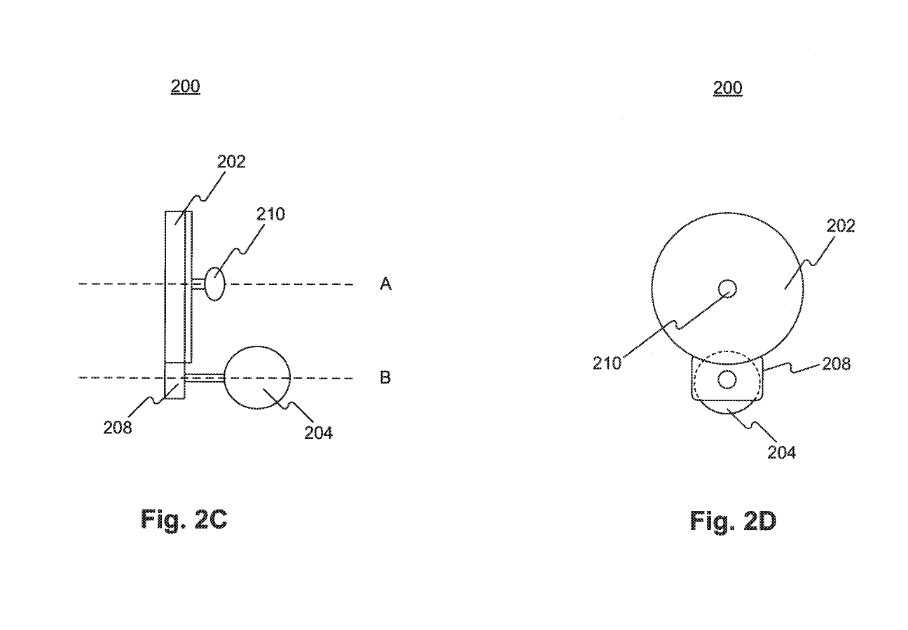

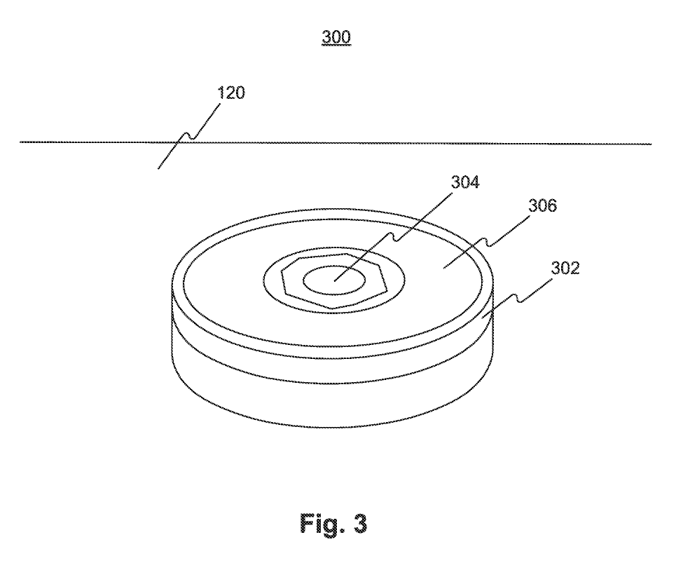

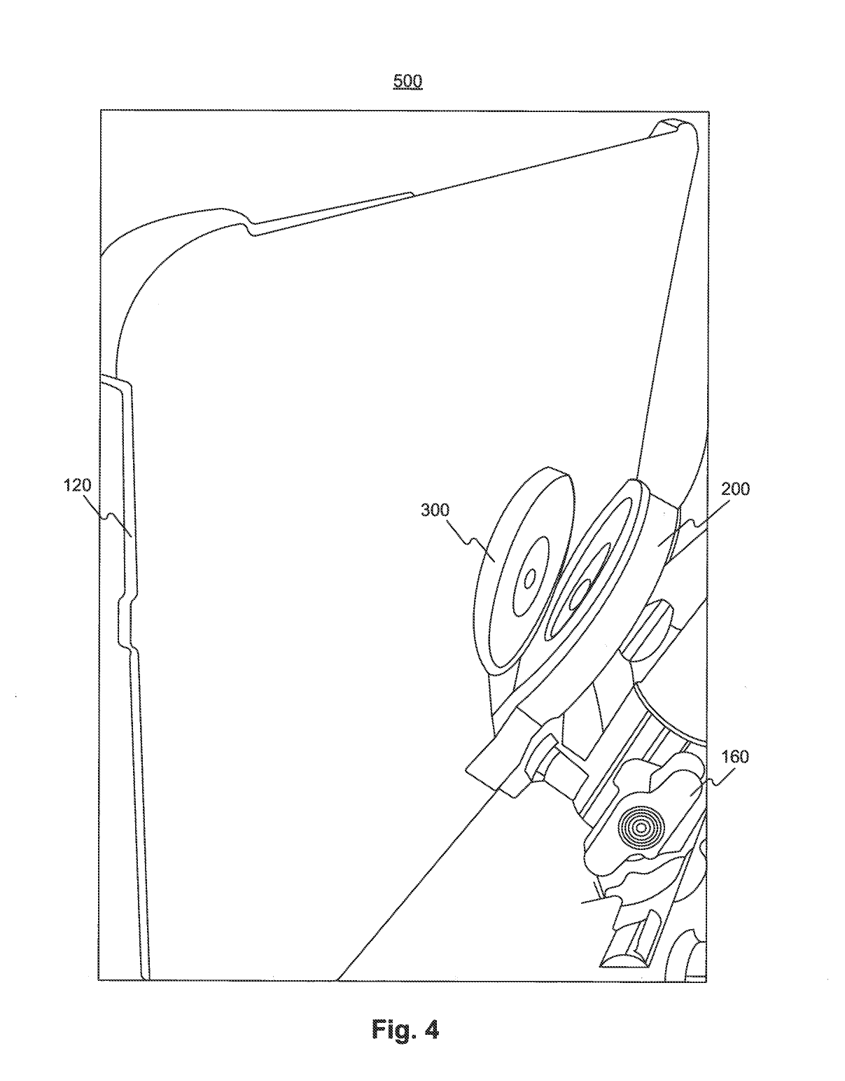

FIG. 1 illustrates an exemplary detachable mounting system 100 according to an embodiment of the present disclosure. As illustrated in FIG. 1, an exemplary detachable mounting system 100 can be used for securing an electronic device 120 and includes a first portion or mounting body 300 that is coupled with the electronic device 120. The first mounting body 300 may include a magnetic mounting piece 306 as shown in FIG. 3. The detachable mounting system 100 also includes a second mounting body 200 that capable of being coupled with a supporting base or surface 160. The second portion or mounting body 200 may include a first end for being coupled to the first mounting body 300, and a second end for being coupled with the supporting base or surface 160. The detachable mounting system 100 also includes a magnetic securing device 206, an example of which is shown in FIG. 2A, which may be detachably coupled between the first mounting body 300 and a first end of the second mounting body 200 for magnetically securing the first mounting body 300 to the second mounting body 200 through magnetic force.

Referring to FIG. 1, the device 120 being coupled with the first portion or mounting body 300 may include an electronic device, such as one of a tablet PC, a tablet (such as an Android® tablet, an Apple iPad® of any generation, and a smart phone). The device 120 may come with a protective case, or the first portion or mounting body 300 itself may provide a protective case or have a case or base integrated or coupled with the magnetic mounting piece 306. As an example, when the device 120 is secured to the supporting base or surface 160 via the first mounting body 300 and the second mounting body 200, the device 120 can be secured or mounted to prevent it from falling, shifting, dropping, lifting, dislocating, or engaging in other undesired movements, either when the device 120 is not in use or is being operated by a user. Referring to FIG. 1, the supporting base or surface 160, which the exemplary detachable mounting system 100 may be coupled with, can provide support or stability to the system.

Referring still to FIG. 1, the first mounting body 300 can be coupled to one of the components of the detachable mounting system 100. As an example, the first mounting body 300 can be coupled to the second mounting body 200. The coupling between them can be through a magnetic securing device 206 (an example shown in FIG. 2) and/or a magnetic mounting piece 306 (shown in FIG. 3). The first mounting body 300 will be described further below with reference to FIG. 3.

The second mounting body 200, as illustrated in FIG. 1, may include a first end that can be coupled to the first mounting body 300, and a second end capable of being coupled to the supporting base or surface 160. The second mounting body 200 may also include at least one movable or extendable arm (with two illustrated in FIG. 1) for providing maneuverability and freedom of movement of the electronic device. In some exemplary embodiments, the movable arm or arms coupled to the supporting base or surface 160 may enable at least one of relative horizontal, vertical, pivoting, swiveling, and rotating movements of the electronic device relative to the supporting base or surface 160.

Accordingly, the second mounting body 200 can be coupled with or attached to both the first mount body 300 and the supporting base or surface 160. With the mounting system 100, the device 120 can be secured, but can also be allowed to having movement, such as one or more horizontal, vertical, pivoting, swiveling, and rotating movements, relative to the supporting base or surface 160 or the second mounting body 200. Also, the various joints, clamps, screws illustrated here can be loosened or tightened to allow or restrain the degree of movements and provide the necessary flexibility or stability. As an example, when the first mounting body 300 is coupled to the first end of the second mounting body 200 and the supporting base or surface 160 is coupled to the second end of the second mounting body 200, the device 120 can be secured or substantially secured relative to the supporting base or surface 160. The device 120 can also move with one, two, three, or four degrees freedom relative to the supporting base or surface 160. The securing of the device 120 by the mounting system 100 and its controls, therefore, may allow ease of user operations including the re-positioning, tilting, swiveling, or rotating and horizontal and/or vertical movement of the device.

In some exemplary embodiments, the second end of the second mounting body 200 may be coupled with the supporting base or surface 160 through a ball (or T-ball) or a substantially spherical joint to provide additional freedom of movement or adjustability. In one embodiment, the second or lower end of the second mounting body 200 may include one of a clamp, a screw mount, a wall/desk/ceiling mounting piece, and a dashboard, seatback, headrest, vent, window, sunroof, or center console mount for vehicles so the second mounting body can be mounted to various bases or surfaces. One of ordinary skill in the art would appreciate that the second end can have various shapes, mechanisms, or structures for enabling the securing of the second mounting body 200 to the supporting base or surface 160.

In some exemplary embodiments, the detachable mounting system 100 includes a magnetic securing device 206 (shown in FIG. 2A), for the purpose of coupling to or securing the first mounting body 300, such as through the magnetic mounting piece 306. A quick-mount (or quick-release) securing device may be used with the magnetic mounting piece 306 for easy but secure (or securable) retention of the electronic device 120.

FIG. 2A illustrates a perspective view of the first end the second mounting body 200 of the detachable mounting system 100 as illustrated in FIG. 1. Referring to FIG. 2A, the second mounting body 200 includes a first portion 202 and a second portion 204. The first portion of the second mounting body 200 may includes the magnetic securing device 206, which may be detachably coupled between the first mounting body 300 (shown in FIG. 1) and the first end of the second mounting body 200. The magnetic securing device 206 can further include a securing latch (or a securing and releasing latch 210.

Referring to FIG. 2A, the first portion 202 can be coupled to the first mounting body 300 (shown in FIG. 1). The first portion 202 may be a mounting cap or plate. As an example illustrated in FIG. 2A, the mounting cap or plate may be a round-shaped one and may have a protruded edge surrounding the cap or plate to increase the security of the coupling. The round shape of the first portion 202 (with or without the protruded edge) may enable an electronic device, which may be attached to the first mounting body 300 that fits within the first portion 202, to rotate freely while being attached or mounted. One of ordinary skill in the art would appreciate that the first portion 202 can have any other desired shape for enabling the coupling of the second mounting body 200 to the first mounting body 300.

Referring still to FIG. 2A, the second portion 204 can be a ball-joint or a pivoting or swiveling mechanism for enabling the coupling to the rest of the second mounting body 200, such as the portion coupled with the supporting base or surface 160. In FIG. 2A, as an example, the second portion 204 may include a ball, a T-ball, or a substantially spherical joint. Therefore, the various designs described above regarding the second mounting body 200 can enable at least one of relative horizontal, vertical, pivoting, swiveling, and rotating movements of the electronic device 120 relative to the second mounting body 200 or the supporting base or surface 160. Therefore, the second mounting body 200 may enable a user to adjust the positioning of the device 120 with various viewing, rotating, angular, horizontal, and vertical positions relative to the supporting base and surface 160.

Referring still to FIG. 2A, the second mounting body 200 includes a magnetic securing device 206, which may be detachably coupled between the first mounting body 300 (shown in FIG. 1) and the upper or first end of the second mounting body 200. The magnetic securing device 206 may include at least one of a permanent magnet and a ferromagnetic material. Similarly, the corresponding mounting piece 306 may include at least one of a permanent magnet and a ferromagnetic material so magnetic force would attract the magnetic securing device 206 to the corresponding mounting piece 306 or vice versa. In some exemplary embodiments, the permanent magnet may be a neodymium (NdFeB, NIB, or Neo) magnet. Thus, the magnetic securing device 206 can enable the securing of the first mounting body 300 through magnetic force that exists between the magnetic securing device 206 and an optional magnetic mounting piece 306 (shown in FIG. 3). As a result, when the first mounting body 300 is secured by the magnetic securing device 206, it can be prevented from falling, shifting, dropping, lifting, dislocating, or engaging in other undesired movements, which may be caused by gravity, vibration, force of a user operation, or a combination thereof.

As a non-limiting example, FIG. 2A illustrates that the magnetic securing device 206 is of a circular shape or a concentric shape. One of ordinary skill in the art would appreciate that any other desired shape may be implemented or used for obtaining a desired level of magnetic coupling. In some exemplary embodiments, a corresponding magnetic mounting piece 306 may be included in the first mounting body 300, as will be discussed below in association with FIG. 3.

Moreover, in some exemplary embodiments, the first portion 202 of the second mounting body 200 may further include an optional convex or attachment portion 208, for coupling the first portion 202 to the second portion 204. In FIG. 2A, as a non-limiting example, the convex or attachment portion 208 is located at the side of the first portion 202. The convex or attachment portion 208 can also be located directly under the first portion 202 while still allowing the securing and releasing latch 210 to pass through, so that the first portion 202 (such as a magnet and a screw) and second portion 204 (such as a joint or a ball or T-ball joint) are aligned along the same axis. One or ordinary skill in the art would appreciate that any other desired alignment or arrangement of the first portion 202 and the second portion 204 can be implemented, with or without the optional portion 208. In addition, the convex or attachment portion 208 can also enable a user to easily detach or separate the first mounting body 300 from the second mounting body 200, for example, with one hand when the magnetic coupling creates a tightened attachment.

Referring still to FIG. 2A, in some exemplary embodiments, the magnetic securing device 206 may further include the securing latch (or the securing and releasing latch) 210. The securing and releasing latch 210 may include one of a screw, a clamp, a lock, and a quick-release latch. The securing and releasing latch 210 can be coupled to the first portion 202 to screw into or clamp onto the magnetic mounting piece 306 (shown in FIG. 3). In some exemplary embodiments, an enhanced securing of the first mounting body 300 (and the device 120 attached to it) may be desirable to provide additional security or rigidity. The securing and releasing latch 210 can provide additional security or protection by adding an additional securing or latching mechanism. As an example, in FIG. 2A, the first portion 202 may have an opening in its center so that the securing and releasing latch 210, such as a screw, can go through the opening to further secure the first mounting body 300. In this case, a corresponding screw thread may be provided in the first mounting body 300 or the magnetic mounting piece 306. In addition, when the first mounting body 300 is about to be decoupled from the second mounting body 200, the securing and releasing latch 210 can be un-screwed (or un-clamped/unlocked/unlatched) to release the coupling. Furthermore, the securing and releasing latch 210 may also be used as a quick-release latch for separation of the magnetic coupling provided by the magnetic securing device 206. For example, if the securing and releasing latch 210 is attached to the second mounting body 200 but not the first mounting body 300, a user can pull the securing and releasing latch 210 for separating the magnetically coupled bodies.

FIG. 2B illustrates a back view of the second mounting body 200 as illustrated in FIG. 2A. In FIG. 2B, as a non-limiting example, the securing and releasing latch 210 is shown as a screw that can be operated by hand. In addition, the magnetic securing device 206 may be enclosed in the first portion 202 and thus not shown in FIG. 2B. One of ordinary skill in the art would appreciate that the magnetic securing device 206 can be attached or coupled to the first portion 202 in any other manner not shown in FIG. 2B. Furthermore, the securing and releasing latch 210 may further include a security mechanism (not shown in FIG. 2B) comprising at least one of a lock, an alarm, an electrically-controlled lock or magnet, a motion or decoupling sensor, an anti-theft screw for preventing unauthorized removal of the electronic device.

FIG. 2C illustrates a side view of the second mounting body 200 of the detachable mounting system 100 as illustrated in FIG. 2A. As also illustrated in FIG. 2C, the center axis (shown as line “A” extending horizontally in FIG. 2C) of the first portion 202, such as a mounting cap or plate, may or may not be aligned or parallel with the center/vertical axis of the second portion 204 (shown as line “B” extending horizontally in FIG. 2C). That is, the two axes can be parallel (as illustrated) or non-parallel (not shown) with each other. When the two axes are non-parallel, an off-center design is created. When the first mounting body 300 (shown in FIG. 1) is attached to the second mounting body 200, an off-center design may offer additional degrees of freedom in a user's positioning of the device. FIG. 2D shows a front view of the second mounting body 200 as shown in FIG. 2A. One of ordinary skill in the art would appreciate that the relative position of the first portion 202, the second portion 204, the magnetic securing device 206, and the optional convex portion 208 can be arranged in any desired manner and not be limited to the arrangement shown in FIG. 2A-FIG. 2D.

FIG. 3 illustrates a perspective view of a first mounting body 300 of the detachable mounting system 100 as illustrated in FIG. 1. As shown in FIG. 3, the first mounting body 300 includes a mounting end 302 and a magnetic mounting piece 306. The magnetic mounting piece 306 may also comprise a screw thread 304. In some exemplary embodiments, the first mounting body 300 is attached to or embedded within a back cover or case of the device 120, such as various generations of iPad®.

Referring to FIG. 3, the magnetic mounting piece 306 comprises at least one of a permanent magnet and a ferromagnetic material. In some exemplary embodiments, the magnetic mounting piece 306 comprises a neodymium (NdFeB, NIB, or Neo) magnet. The magnetic mounting piece 306 enables the magnetic securing of the first mounting body 300. For example, the magnetic mounting piece 306 can prevent the detaching of the first mounting body 300 from the second mounting body 200 caused by gravity, vibration, force of a user operation, or a combination thereof. As an example illustrated in FIG. 3, the magnetic mounting piece 306 can be a circular shape or a concentric shape. One of ordinary skill in the art would appreciate that any other desired shape may be implemented or used for obtaining a desired level of magnetic coupling. In some exemplary embodiments, the magnetic mounting piece 306 corresponds to the magnetic securing device 206 as shown in FIG. 2A, for creating a magnetic coupling. In some exemplary embodiments, only one of the magnetic securing device 206 and the magnetic mounting piece 306 may be required for creating a magnetic coupling.

Referring still to FIG. 3, the magnetic mounting piece 306 includes a screw thread 304 that is compatible with the securing and releasing latch 210 (shown in FIG. 2A) and a standard camera tripod using 1/4-20 UNC threads (not shown). Thus, the screw thread 304 enables the coupling of the securing and releasing latch 210, such as a screw, and coupling of a camera tripod, to the second mounting body 200. One of ordinary skill in the art would appreciate that the screw thread 304 can be any size or any shape that is compatible with the desired securing and releasing latch 210.

FIG. 4 illustrates a perspective view of the first mounting body 300 being attached to the second mounting body 200 of the detachable mounting system 100 as illustrated in FIG. 1. As discussed above, in some exemplary embodiments, at least one of the magnetic mounting piece 306 (shown in FIG. 3) and the magnetic securing device 206 (shown in FIG. 2A) comprises one or both of a permanent magnet and a ferromagnetic material. As a result, the magnetic securing device 206, with or without the magnetic mounting piece 306, can magnetically secure the first mounting body 300 to the second mounting body 200 through magnetic force, which exists between the magnetic mounting piece 306 and the magnetic securing device 206. FIG. 4 illustrates that the first mounting body 300 is being coupled to the second mounting body 200 through magnetic force.

As a result of the magnetic force, the first mounting body 300 and the second mounting body 200 can be coupled and/or aligned easily or effortlessly while offering certain level of security against gravity, vibration, force of a user operation, or a combination thereof. The easy alignment created by the magnetic securing device 206 and/or the magnet mounting piece 306 may also enable the securing and releasing latch 210, such as a screw, to be easily aligned and attached. As an example, the magnetic coupling may allow a user to tighten a screw with one hand, without the need to use the other hand to hold the device in position.

A typical electronic device, such as the device 120, may require charging and/or signal communication. Thus, the detachable mounting system 100 can further include conductive contacts (not shown). The conductive contacts may be coupled with at least the first mounting body 300, for the purpose of charging and/or communicating with the electronic device 120. In some exemplary embodiments, the first mounting body 300 and the second mounting body 200 may each or both include conductive contacts for enabling the charging and/or signal communication of the device 120. In addition, when the device 120 is charging or communicating with an external power source or device, the device 120 may still need to be rotated or manipulated. For example, a user may want to rotate the device 120 horizontally for making a presentation or slideshow. Thus, to allow the device 120 to rotate without affecting the conductive coupling or signal communication, one or both of the first mounting body 300 and the second mounting body 200 may include co-centric, partially co-centric, or other conductive traces for the conductive couplings.

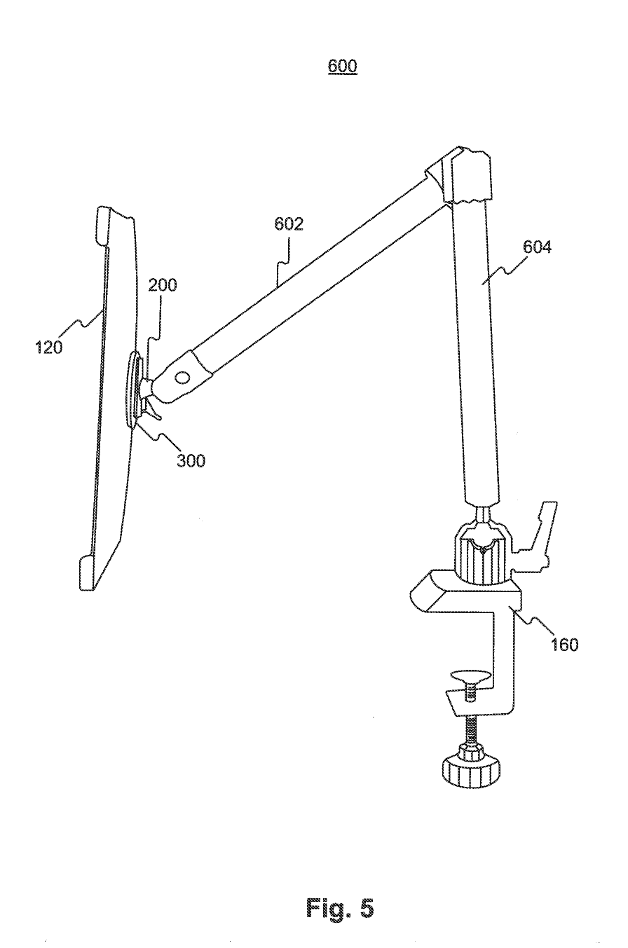

FIG. 5 illustrates a view of an exemplary embodiment 600 of the detachable mounting system 100 as shown in FIG. 1. The exemplary embodiment 600 includes the device 120; the first mounting body 300; and the first mounting body 200, which may or may not include a first arm 602 and a second arm 604. The exemplary embodiment 600 also includes the supporting base or surface 160. The device 120, the first mounting body 300 and the second mounting body 200 (not including the arms 602 and 604) can be similar or substantially similar to those described above and thus are not repeated here.

FIG. 5 shows, as an example, that the supporting base or surface 160 is a clamp. The supporting base or surface 160 may also have various configurations, such as a metal or otherwise heavy, stabilized, or mounted base; a ceiling or top mount for attaching to a wall or surface; a base for screw- or adhesive-mounted configuration; a dashboard, seatback, headrest, vent, window, sunroof, or center console mount for vehicles; or some combination thereof. One of ordinary skill in the art would appreciate that these are merely exemplary variations, and the design and configuration may vary to provide the stability and/or needed for various applications of users. The supporting base or surface 160 can enable the securing of the detachable mounting system 100 to a wall, desk, ceiling, shelf, cabinet, vehicle dashboard, vehicle seatback, vehicle headrest, vehicle vent, vehicle window, vehicle roof or sunroof, and vehicle center console, etc.

In some exemplary embodiments, as illustrated in FIG. 5, at least one movable arm (602 or 604) is coupled with the magnetic securing device 206 (not shown) of the second mounting body 200 and the supporting base or surface 160. In addition, the two arms 602 and 604, as shown in FIG. 5, can be coupled with a joint between them, for providing at least one degree of freedom between the two arms. Furthermore, at least one of the two arms (602 or 604) is coupled to the supporting base or surface 160 through a clamp, a screw mount, a wall/desk/ceiling mounting piece, a joint, and a dashboard, seatback, headrest, vent, window, sunroof, or center console mount for vehicles. The moveable arms can enable at least one of relative horizontal, vertical, pivoting, swiveling, and rotating movements of the electronic device 120 relative to supporting or surface base 160.

The accompanying drawings and pictures are solely for illustrating certain embodiments, exemplary aspects, and optional designs of the disclosed embodiments. Therefore, the specific designs, dimensions, shapes, and configurations illustrated here and described above are not intended to and do not limit the scope of the disclosed embodiments. Moreover, it will be apparent to those skilled in the art from consideration of the specification and practice of the present disclosure that various modifications and variations can be made to the disclosed systems without departing from the scope of the disclosure. Therefore, the specification and examples are exemplary only, with the intended scope described in the claims.

What is claimed is:

1. A detachable mounting system for securing an electronic device, comprising:
a first mounting body coupled with the electronic device, the first mounting body comprising a magnetic mounting piece;
a second mounting body capable of being coupled with a supporting base or surface, the second mounting body comprising:
a first end being coupled to the first mounting body,
a second end capable of being coupled with the supporting base or surface, wherein at least one of couplings with the first and second end enables at least one of relative horizontal, vertical, pivoting, swiveling, and rotating movements of the electronic device relative to the supporting base or surface;
and
a magnetic securing device detachably coupled between the first mounting body and the first end of the second mounting body for magnetically securing the first mounting body to the first end of the second mounting body through magnetic force between the magnetic mounting piece and the magnetic securing device, the magnetic securing device comprising a securing and releasing latch.

2. The detachable mounting system of claim 1, wherein the securing and releasing latch comprises one of a screw, a clamp, a lock, and a quick-release latch coupled with the magnetic mounting piece.

3. The detachable mounting system of claim 1, wherein the magnetic mounting piece has a screw thread compatible with a standard camera tripod using 1/4-20 UNC threads.

4. The detachable mounting system of claim 1, wherein at least one of the magnetic mounting piece and the magnetic securing device comprises at least one of a permanent magnet and a ferromagnetic material.

5. The detachable mounting system of claim 1, wherein at least one of the magnetic mounting piece and the magnetic securing device comprises a neodymium (NdFeB, NIB, or Neo) magnet.

6. The detachable mounting system of claim 1, wherein the first end of the second mounting body comprises a ball, a T-ball, or a substantially spherical joint.

7. The detachable mounting system of claim 1, wherein the second mounting body comprises at least one movable or extendable arm for providing maneuverability and freedom of movement of the electronic device.

8. The detachable mounting system of claim 1, wherein the second end of the second mounting body comprises at least one of a clamp, a screw mount, a wall/desk/ceiling mounting piece, and a dashboard, seatback, headrest, vent, window, sunroof, or center console mount for vehicles.

9. The detachable mounting system of claim 1, further comprising conductive contacts coupled with at least the first mounting body for charging or communicating with the electronic device.

10. The detachable mounting system of claim 1, wherein the securing and releasing latch further comprises a security mechanism comprising at least one of a lock, an alarm, an electrically-controlled lock or magnet, a motion or decoupling sensor, an anti-theft screw for preventing unauthorized removal of the electronic device.

11. The detachable mounting system of claim 1, wherein the electronic device comprises one of a tablet PC, a tablet, an iPad of any generation, and a smart phone.

12. A magnetic mounting system for securing an electronic tablet, comprising:
a mounting piece coupled with the electronic tablet;
a magnetic securing device detachably coupled with the mounting piece through magnetic force between the magnetic securing device and the mounting piece, the magnetic securing device further comprising a securing latch;
at least one movable arm coupled with the magnetic securing device, the at least one movable arm being capable of being coupled to a base, the at least one movable arm being coupled with the magnetic securing device to enable at least one of relative horizontal, vertical, pivoting, swiveling, and rotating movements of the electronic device relative to at least one of the at least one movable arm and the base.

13. The magnetic mounting system of claim 12, wherein the securing latch comprises one of a screw, a clamp, a lock, and a quick-release latch.

14. The magnetic mounting system of claim 12, wherein the mounting piece has a screw thread compatible with a standard camera tripod.

15. The magnetic mounting system of claim 12, wherein at least one of the mounting piece and the magnetic securing device comprises at least one of a permanent magnet and a ferromagnetic material.

16. The magnetic mounting system of claim 12, wherein at least one of the mounting piece and the magnetic securing device comprises a neodymium (NdFeB, NIB, or Neo) magnet.

17. The magnetic mounting system of claim 12, wherein the magnetic securing device is coupled with a first end of the at least one movable arm through a ball, a T-ball, or a substantially spherical joint.

18. The magnetic mounting system of claim 12, wherein the at least one movable arm comprises two arms being coupled with a movable or rotatable joint that provides at least one degree of freedom between the two arms.

19. The magnetic mounting system of claim 12, wherein the base comprises one of a wall, desk, ceiling, shelf, cabinet, vehicle dashboard, vehicle seatback, vehicle headrest, vehicle vent, vehicle window, vehicle roof or sunroof, and vehicle center console.

20. The magnetic mounting system of claim 12, wherein the at least one arm is coupled to the base through a clamp, a screw mount, a wall/desk/ceiling mounting piece, and a dashboard, seatback, headrest, vent, window, sunroof, or center console mount for vehicles.

21. The magnetic mounting system of claim 12, wherein the at least one arm is coupled to the base through a ball, a T-ball, or a substantially spherical joint.

22. The magnetic mounting system of claim 12, further comprising conductive contacts coupled with at least the mounting piece for charging or communicating with the electronic tablet.

23. The magnetic mounting system of claim 12, wherein the securing latch further comprises a security mechanism comprising at least one of a lock, an alarm, an electrically-controlled lock or magnet, a motion or decoupling sensor, an anti-theft screw for preventing unauthorized removal of the electronic device.

24. The magnetic mounting system of claim 12, wherein the electronic tablet comprises one of a tablet PC, a tablet, an iPad of any generation, and a smart phone.
